(19) United States
(12) Patent Application Publication
(10) Pub. No.: US 2004/0230933 A1
(43) Pub. Date: Nov. 18, 2004

(54) Tool flow process for physical design of integrated circuits

(76) Inventors: Edward G. Weaver JR., Sunnyvale, CA (US); Gun Unsal, Sunnyvale, CA (US); Edward R. Helder, Fremont, CA (US)

Correspondence Address: HEWLETT-PACKARD COMPANY, Intellectual Property Administration, P.O. Box 272400, Fort Collins, CO, 80527-2400, US

(21) Appl. No.: 10/438,580

(22) Filed: May 15, 2003

(51) Int. Cl. G06F 17/50

(52) U.S. Cl. 716/12

(57) ABSTRACT

A circuit design flow process comprises using a mapped gate-level netlist to pre-place critical electrical infrastructure on an integrated circuit (IC) die to ensure repeatability, and placing the remaining electrical infrastructure on the IC die.

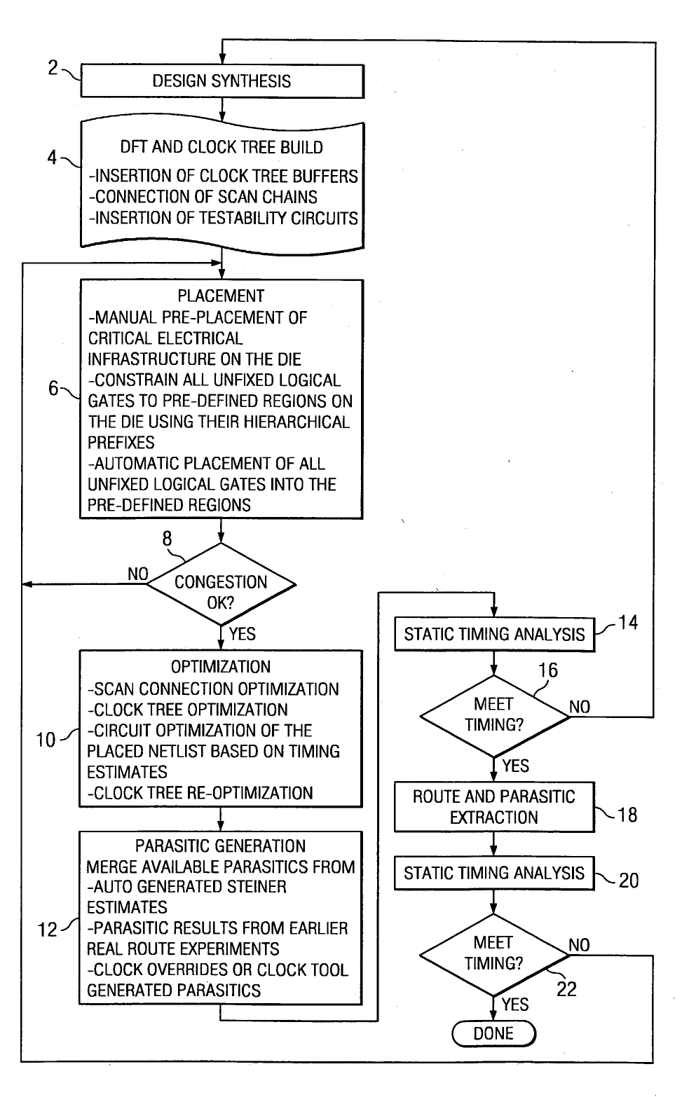

### FIELD OF INVENTION

The present disclosure relates generally to development of integrated circuits (ICs) and more particularly to a tool flow process for physical design of ICs.

### DESCRIPTION OF RELATED ART

An integrated circuit (IC) typically includes thousands of transistors fabricated on a monolithic crystalline lattice usually comprised of silicon or other semiconductor material. The transistors are selectively interconnected through the use of one or more interconnect layers comprised of conductive material to achieve a particular functionality which is dictated by the application to which the integrated circuit is directed. As application specific integrated circuits (ASICs) become more complex, various computer aided design (CAD) tools are being used to more efficiently design such circuits. The time required for a full scale design is greatly reduced by drawing from a library of pre-defined cells that have been fully characterized for a given wafer process flow.

One CAD tool commonly used in integrated circuit design is a synthesis tool. The synthesis tool receives a description of the circuit, typically in hardware description language (HDL) which functionally describes the circuit, and outputs a description (netlist) of the circuit which corresponds to the actual circuit being formed on a semiconductor wafer. A netlist is a detailed list of circuit elements which will to produce the ASIC and the interconnections among the various circuit elements.

If the design is functionally correct and meets basic timing criteria, the netlist is passed as input to a software placement tool. Placement involves allocating each cell of the design to a physical location on the silicon chip such that the cells could subsequently be interconnected by routing software. A group of cells (cell block) which performs a certain function, and blocks of cells which are closely related electrically, are physically placed as close as possible to each other. Physical proximity conserves space on the chip, simplifies routing and enhances circuit performance. Placement is also concerned with excess capacitance and resistance values caused by long interconnect paths between cells which may cause signal delays and lead to functional failures. Another goal of placement is to allocate the cells such that interconnections between cells are minimized and undue routing congestion is avoided. Placement may be done manually and/or automatically. If placement is done manually, the designer directs the software placement tool to a particular location on the chip (die) where a cell or a block of cells is to be placed. Automatic placement uses sophisticated algorithms and a pre-defined cell library to allocate the cells to various locations on the chip. Each cell in the library contains a variety of attributes describing the function, timing and other information related to each cell.

After placement is complete, a software router tool is used to generate an interconnected layout of the ASIC. The purpose of routing is to connect points in each net of the logic design so that the connections required between cells are complete. The router tool performs the interconnections to ensure most efficient area utilization. The router tool also takes into account timing considerations for worst case delay paths. Actual parasitic capacitances and resistances are fed into an analyzer which provides an accurate assessment of circuit performance under various process and temperature conditions. If any routing problems become evident, appropriate design changes are made. If no routing problems become evident, masks for fabricating the circuit may be generated.

In general, routing problems can be significantly reduced if the cells have been optimally placed during the placement stage. Incorrect placement of cells may lead to layout failure which in some cases only becomes apparent at the end, i.e. when the final few connections are being added. Hence, it is critical that optimal placement of the cells is achieved during the placement stage. However, some standard placement-based synthesis tools do not work well on large-size ASIC chip designs. In other CAD tools, optimization is done relatively late in the design cycle which may result in re-synthesis or too many iterations due to discrepancy between parasitics from different sources. Also, existing non-placement based synthesis tools do not produce circuits which successfully close in timing and area since such tools typically use wireload model estimates.

### BRIEF SUMMARY OF THE INVENTION

An embodiment of the present invention is directed to a circuit design flow process comprising using a mapped gate-level netlist to pre-place critical electrical infrastructure on an integrated circuit (IC) die to ensure repeatability, and placing the remaining electrical infrastructure on the IC die.

Another embodiment of the present invention provides a circuit design flow process comprising, generating a mapped gate-level netlist, and using the gate-level netlist to pre-place critical electrical infrastructure on an integrated circuit (IC) die to ensure repeatability.

An embodiment of the present invention provides a circuit design flow process comprising, generating a mapped gate-level netlist, running the gate-level netlist through a design-for-test (DFT) and clock tree build stage, and using the resultant netlist to pre-place critical electrical infrastructure on an integrated circuit (IC) die to ensure repeatability.

Another embodiment of the present invention provides a tool flow process for physical design of an integrated circuit (IC), comprising, using a design synthesis tool to generate a mapped gate-level netlist, using a master script to call a first tool to perform a design-for-test (DFT) and clock tree build of the gate-level netlist, the resultant netlist containing critical electrical infrastructure for utilization in the IC physical design, using the master script to call a second tool to perform pre-placement of the critical electrical infrastructure on an IC die to ensure repeatability, using the master script to call the second tool to perform placement of the remaining electrical infrastructure on the IC die, the placements constituting a placed netlist, and using the master script to call the second tool to perform circuit optimization of the placed netlist based on timing estimates.

### BRIEF DESCRIPTION OF THE DRAWINGS

The FIGURE is a flow chart of a tool flow process for physical design of an integrated circuit in accordance with an embodiment of the present invention.

### DETAILED DESCRIPTION

Hereinafter, some preferred embodiments of the present invention will be described in detail with reference to the related drawings of the FIGURE. Additional embodiments, features and/or advantages of the invention will become apparent from the ensuing description or may be learned by practicing the invention.

The following description includes the best mode presently contemplated for carrying out the invention. This description is not to be taken in a limiting sense, but is made merely for the purpose of describing the general principles of the invention.

In developing the present invention, it has been discovered that an improved IC design methodology may utilize manual placement of certain critical circuit elements followed by circuit optimization based on timing estimates at an early stage in the design process. Therefore, embodiments of the present invention are generally directed to a tool flow process for physical design of an IC, such as an ASIC, which includes manual pre-placement of certain critical circuits followed by circuit optimization based on timing estimates at an early stage in the design process. Specifically, the pre-placement process may involve locating and fixing strategic electrical infrastructure such as clock trees, electro-static discharge (ESD) protection circuits, input/output (IO) circuits, bitstacks, etc. followed by automatic placement of the remainder of the chip circuits. A starting point for estimation of parameters such as parasitics, timing, routing congestion and circuit area is thus established which improves the accuracy and stability of the estimated parameters. Consequently, this speeds up the design iterative loop and design phase, maximizes die usage and frequency, and improves the predictability of the results.

Turning to the FIGURE, a flow diagram of design of an integrated circuit in accordance with an embodiment of the present invention is shown. The flow chart of the embodiment illustrated in the FIGURE begins with design synthesis step 2. Design synthesis step 2 is preferably performed using DESIGN COMPILER™ which is a circuit design synthesis software tool which may be purchased from Synopsys, Inc. of Mountain View, Calif., or other suitable circuit design synthesis tool. Synthesizing an ASIC design is an iterative process which begins with defining the timing constraints for each block of the design. The timing constraints define the relationship of each signal relative to the clock input for a particular block. A file defining the synthesis environment is also typically utilized. The synthesis environment file specifies the cell libraries and other relevant information used by the circuit design synthesis tool during synthesis. The command line interface of the Synopsys synthesis tool mentioned above may be invoked, for example, by either typing dc_shell or dc_shell-t in a UNIX® shell. The dc_shell command is based on Synopsys's own language, while the dc_shell-t command is based on the standard Tcl language. The circuit design synthesis tool may then read the register transfer level (RTL) code of the design using the timing constraints and synthesizes the code to a structural level, i.e. generating a mapped gate-level netlist.

The generated gate-level netlist may be run through a DFT (Design-For-Test) and clock tree build step 4 utilizing an IBM™ software BOOLEDOZER™ tool, which is part of the IBM BLUE LOGIC® software design methodology flow tool suite used industry-wide and available commercially from the IBM Corporation of Waltham, Mass., or other logic synthesis tool. Specifically, clock tree build of the illustrated embodiment involves inserting the clock tree buffers (step 4 of the FIGURE).

DFT techniques are increasingly becoming popular among ASIC designers as merging testability early in the design cycle generally leads to reduced debugging time normally spent at the tester after the ASIC has been fabricated. Two of the main DFT techniques currently used by ASIC-designers include scan insertion, and boundary scan insertion. Boundary scan is normally used to test the board connections without unplugging the chip from the board. Scan is a well-known technique used by chip designers to test the chip for defects such as, for example, stuck-at faults. Scan insertion entails replacing all the flip-flops in the design with special flops containing built-in logic for testability purposes. For example, a well-known architecture entails the use of a multiplexed flip-flop which basically involves the incorporation of a 2-input MUX at the input of a D-type flip-flop. The select line of the MUX defines the operational mode of the device, i.e. whether the MUX is in a normal operational mode (normal data coming in) or in a test mode (scanned data coming in). The scan-flops are linked together using the scan-data input of the MUX to form a scan chain which functions like a serial shift register. Another example is IBM's method of LSSD-level sensitive scan design which utilizes a master and slave latch, and multiple clocks.

After the clock tree buffers have been inserted, the logic synthesis tool may be used to connect the scan chains, insert testability circuits such as MUXs and boundary scan circuits, and run scripts to add other structures to the netlist such as decoupling capacitors for the top level logic hierarchy.

A person skilled in the art would recognize that other software tools/techniques may be utilized to incorporate early testability features in the ASIC design as long as such other tools/techniques do not depart from the intended purpose of the present invention. For example, Synopsys® adds DFT capabilities to the DESIGN COMPILER™ suite of tools through its DFT Compiler (DFTC) which may be invoked, for example, by: dc_shell-t>set_scan_configuration-style multiplexed_flip_flop *** followed by insert_scan ***. The command to stitch the scan chains in Physical Compiler™ may be invoked, for example, by: ***insert_dft***.

In accordance with a preferred embodiment of the present invention, a script may be generated using CHIPBENCH™ (a front end software floor-planning tool from the IBM™ BLUE LOGIC™ design flow tool suite), or other suitable design tool, commands which would select by name and characteristic various critical electrical infrastructure from the (DFT and clock tree built) netlist and interact with the designer to manually pre-place (fix) the same in a specific order in respective pre-set areas on the die at a relatively early stage in the design process to ensure repeatability, step 6 of the FIGURE. Such a script may call a plurality of sub-scripts in a pre-determined order to allow the designer to locate and manually pre-place certain critical electrical infrastructure on the die early in the physical design process. For example, the various sub-scripts may be programmed to run as follows:

Sub-script 1. Locate and pre-place (fix) IO (input/output) circuitry to ensure that IO macros (cell library elements containing groups of IO circuits) are close to their respective C4 bumpouts (input/output ports on the die);

Sub-script 2. Locate and pre-place (fix) electro-static discharge (ESD) protection circuits which are to be disposed within a certain distance of the IO macros;

Sub-script 3. Locate and pre-place (fix) large register arrays/files, i.e. large macro files that function as arrays of flip-flops so that they are more compact than discrete flip-flops;

Sub-script 4. Locate and pre-place (fix) clock tree buffers as optimally as possible in the remaining die area in an H-tree format;

Sub-script 5. Locate and pre-place (fix) bitstack (standard cell gate) structures such as high-speed link interfaces;

Sub-script 6. Locate and pre-place (fix) certain critical data paths such as synchronizers and repeaters, and circuits that need certain balancing for their routes to match resistances, loads or delays for electrical needs;

Sub-script 7. Locate and pre-place (fix) de-coupling capacitors that have to be disposed in large stacks and in small numbers at regular intervals around the chip;

Sub-script 8 (prefill step). Insert N-well taps at regular intervals around the chip (die);

Sub-script 9. Locate and pre-place (fix) boundary scan circuits which are placed next to the IO circuits such as MUXs and flip-flops used for scan paths;

Sub-script 10. Locate and pre-place (fix) de-coupling capacitors that have to be disposed close to the IO macros and around the clock tree buffers. The remainder of the de-coupling capacitors may be constrained to region bounds and placed using the ‘cplace’ command in CHIPBENCH™, for example; and

Sub-script 11. Snap desired gates closer to other gates, if needed. Some examples may include pulling metastability flip-flops close together, or putting a buffer close to a register file output pin if the pin has a weak drive capability such as to avoid electromigration type problems, etc.

Having fixed the critical electrical infrastructure early in the design process, the ASIC designer may also use the design tool, e.g., CHIPBENCH™, to constrain all unfixed logical gates to pre-defined regions on the die using their hierarchical prefixes in accordance with standard practice, step 6 of the FIGURE. Region constraints are perimeters defining which cell blocks should be placed together and in what location on the die.

Thereafter, the ASIC designer may utilize the gate placement command ‘cplace’ in CHIPBENCH™, or similar functionality of another design tool, to automatically place all unfixed logical gates into the pre-defined regions in accordance with standard practice, step 6 of the FIGURE. These regions may be pre-defined by means of a script which dictates which prefixes in the gate names go into which region. The ‘cplace’ algorithm defines where all the gates would go in the regions using their connectivity information. A person skilled in the art would recognize that this placement run may also be done using timing constraints, which would make ‘cplace’ run in a timing-based mode.

Upon completion of step 6, placement of the cells is checked for circuit congestion, step 8 of the FIGURE. For example, the ASIC designer may use CHIPBENCH™ to check the placed cells for circuit congestion. Specifically, CHIPBENCH™ may be used to estimate how easy it would be to wire all cells together. If congestion problems are encountered, the designer may modify the early manual pre-placements, change the region constraints, or return to design synthesis (step 2, of the FIGURE). After all congestion problems are fixed, or if no congestion problems are encountered, the placed netlist, preferably, goes through an optimization step, step 10 of the FIGURE.

For example, CHIPBENCH™ may be used to perform standard scan connection optimization of the placed netlist. The scan connection optimization step may be desirable since BOOLEDOZER™ is designed to connect the scan chains using an alphabetical naming convention which, after the placement run, may result in the flip-flops (that are scan connected to each other) being disposed not physically close to each other. One of the reasons scan connections are made by BOOLEDOZER™ according to one embodiment is that the tool models the extra load on a flip-flop output early on and the chain lengths are known and balanced. The ‘ScanOpt’ command in CHIPBENCH™ may be utilized to re-arrange the scan connections in a certain chain based on placement proximity. Other techniques and/or tools may be used to perform scan connection optimization after placement, such as, for example, PHYSICAL COMPILER™ from Synopsys, Inc. Scan connection optimization is followed by standard clock tree optimization of the placed netlist according to the illustrated embodiment.

In accordance with another embodiment of the present invention, CHIPBENCH™ may be utilized to perform circuit optimization of the placed netlist based on timing estimates at a relatively early stage in the design process, step 10 of the FIGURE. A person skilled in the art would readily recognize that performing early circuit optimization of the placed netlist provides a good starting point for estimation of parasitics, timing, routing, congestion and circuit area which improves the accuracy and stability of these parameters. Specifically, the ‘TDCopt’ command in CHIPBENCH™ may be used to resize gates, clone gates, re-power nets to meet timing estimates, and the like.

In accordance with yet another embodiment of the present invention, the designer may use the ‘ClockOpt’ command in CHIPBENCH™ to perform clock tree re-optimization of the placed netlist which is essentially a fine-tuning step. Clock tree re-optimization is generally desired, since after the ‘TDCopt’ step (described hereinabove) some of the flip-flops may have changed size. The size changes may affect the loads on the clock tree buffers as the input capacitance of the flip-flops has changed. As a result, the clock tree may not be as skew balanced as it was before. Specifically, the clock tree that was built previously will now have different clock pin sinks, i.e. there could be worse clock skew relative to the previous clock tree. Hence, fine-tuning the clock tree leaves at this stage would help keep the clock skew down and prevent problems downstream in meeting timing requirements. Some of the critical clocks may be re-built to account for the new flip-flop sizes. Furthermore, the reset clock tree and the test clocks related to these flip-flops may be optimized as well, but not as stringently, since their timing requirements are much more relaxed. Specifically, the ‘ClockOpt’ algorithm is programmed to decide what the new buffer sizes and new clock tree structure should look like and optimally place the buffers on the die.

Step 12 of the FIGURE deals generally with generating estimated routes and parasitics for the placed netlist, and, more specifically, with merging available parasitics (resistance and capacitance values) from (1) automatically generated global route (Steiner) parasitic estimates for signals, (2) parasitic results from earlier real route experiments, and (3) clock overrides or clock tool generated parasitics, in accordance with an embodiment of the present invention.

Global route parasitics may be generated using the ‘route_global’ command in CHIPBENCH™ which does not perform a detailed route, but instead estimates into which tiles (gcells) on the chip the routes would generally fall. The ‘route_global’ algorithm is programmed to decide which signals would go through which tiles. However, the algorithm does not assign these signals exactly based on which routing channel is used. The algorithm only has information on how many wires would have to cross a tile. Thus, if the number of wires that go through a tile is more than the total number of routing channels which can be accommodated, the tile would be over-congested. Specifically, the ‘route_global’ algorithm provides a color map of how congested the whole die is. If there are too many congested areas, the designer would make changes to the floor plan or move things around, or make the die larger until all congested areas are eliminated.

Whenever parasitic data from previous real route experiments is available and the placement of some of some previously fixed gates such as clock buffers and bitstacks, has not changed, the designer can use the earlier experimental parasitic values instead of global route parasitic (Steiner) estimates. As a general rule, as soon as the designer is certain that these gates are not going to move on the die and the two end points are fixed in location—for example, from C4 to the IO or from the IO to bitstack—then, the designer can route the signals between fixed gates once and use real parasitics from that point on instead of global route parasitics to shorten the overall design cycle.

The designer may also use the ‘clockPro’ command in BOOLEDOZER™ to obtain parasitic estimates for clocks. The ‘clockPro’ algorithm (clock tool) builds the initial clock tree and provides estimates of what the parasitics would be. Until real clock tree routes are performed, these parasitic estimates can be used. If no parasitic estimates or real route data is available, the chip designer may use clock overrides to make the clocks ideal, step 12 of the FIGURE.

Step 14 of the FIGURE deals with running standard static timing analysis on the placed netlist with global route/estimated routes which may be performed using EINSTIMER™, also part of the IBM BLUE LOGIC® software design flow tool suite. This type of analysis times all circuits in the design to determine whether the specified clock periods are met. If certain paths fail to meet the prescribed timing requirements, the designer may go back to step 2 (design synthesis), as generally shown in block 16 of the FIGURE, or back to placement step 6 depending on the severity of the problem.

In accordance with yet another embodiment of the present invention, a master script may be generated using IBM BLUE LOGIC® ASIC design flow tool suite commands which would automatically call each of the above-identified tools in a predetermined order. Such a master script may incorporate the (early manual) pre-placement script referred to hereinabove, and simplify and streamline the ASIC design tool flow process while enabling first-time-right design efficiency. A person skilled in the art would readily recognize that incorporating a master script of this kind in the ASIC design tool flow process would readily translate into reduced development time and costs, allowing designers to bring their complex designs to market quickly.

In accordance with one exemplary embodiment of the present invention, the following master script (which incorporates the various pre-placement sub-scripts described hereinabove) was generated in connection with a tool flow process for physical design of an ASIC intended generally for a PCIX-based server application:

PART 1: Steps up to TDCOpt
# set prefix for current run
set prefix “VIM0426_pass1”
set edif_tag “EDIF042601”
echo [exec date]
echo $auto_path
# this list path that CB searches for tcl scripts
echo [get_parm_path]
# the constraints file gives coordinates and cell types of IOs, ESD cells, etc
read_parms -command read_design -file ${prefix}_before_init.parms
report_parm -command read_design
read_design -initialize -pdl_package_file {IA3D12886_A0} -chip_image {IA3D12886}
nitialize_power -design_object_type {chip} -constraints_file {HDP_PDL.FP11}
# Write out initialized chip
exec mkdir -p ${prefix}_after_init
write_design -directory ${prefix}_after_init -name {top} -no_children
write_parms -command read_design -file ${prefix}_after_init.parms
current_cell -root
check_placement -overlap
# Scan trace
trace_scan_path -hierarchy_levels 99 -output_directory {HDP/reports} -chain_types {all}
# Save as_after_scanTrace
exec mkdir -p VIM/${prefix}_after_scanTrace
write_design -directory VIM/${prefix}_after_scanTrace -name {top} -no_children
write_parms -command read_design -file etc/app-parms/${prefix}_after_scanTrace.parms
# Trace clock nets
source tcl/clock_trace.tcl
# save as_clockTrace
exec mkdir -p VIM/${prefix}_after_clockTrace
write_design -directory VIM/${prefix}_after_clockTrace -name {top} -no_children
write_parms -command read_design -file etc/app-
parms/${prefix}_after_clockTrace.parms
# make blocks
source tcl/create_hier.tcl
# Now estimate block size
source tcl/place_size_rlms_core.tcl
echo [cputime]
# place and size of rlms (blocks)
current_cell -root
echo “############ Placing and sizing blocks ##############”
source tcl/move_and_size_rlms.tcl
current_cell -root
# save as_hier FORCE SAVE
exec mkdir -p VIM/${prefix}_HIER_PLACED
write_design -all -directory VIM/${prefix}_HIER_PLACED -name {top}
write_parms -command read_design -file etc/app-parms/${prefix}_HIER_PLACED.parms
# flatten and create movebounds
# Generated by generate_placeSizeRlmsCore_createMb.pl
# After this step, the Register Arrays are back on the top level, in the lower left hand of the chip
# Need to click on Cell GROUP movebounds to see them
echo “############ Creating movebounds ###########”
source tcl/create_mb.tcl
echo “############ Removing ioaffinity gates from movebounds ###########”
source tcl/remove_from_mbound.tcl
echo “############ Adding decaps to movebounds ###########”
source tcl/add_decaps_to_mbounds.tcl
echo “############ Setting last_unused for place_old_decap.tcl end point to: $last_unused”
echo “ Set in add_decaps_to_mbounds.tcl script”
current_cell -root
# Save as_mbounds
exec mkdir -p VIM/${prefix}_mbounds
write_design VIM/${prefix}_mbounds -name {top} -no_children
write_parms -command read_design -file etc/app-parms/${prefix}_mbounds.parms
echo [cputime]
# place clock buffers (SCB), register files (RA), bitstacks and balanced route gates
echo “############ Placing RAs ##############”
source tcl/place_ra.tcl
echo “############ Placing SCBs #############”
source tcl/place_scb.tcl
echo “############ Placing bitstacks ############”
source tcl/place_bstack.tcl
echo “############ Sourcing new bstacks... ############”
current_cell -root
source tcl/place_io_bstack.tcl
echo “############ Placing balanced route related gates #####”
current_cell -root
source tcl/balanced_route_placement.tcl
echo [cputime]
current_cell -root
check_placement -overlap
# Save as_fixed
exec mkdir -p VIM/${prefix}_fixed
write_design -directory VIM/${prefix}_fixed -name {top} -no_children
write_parms -command read_design -file etc/app-parms/${prefix}_fixed.parms
# more decaps
echo “############ Placing NEW DECAPS ###############”
source tcl/place_new_decaps.tcl
echo [cputime]
current_cell -root
check_placement -overlap
# save as_large_decaps
exec mkdir -p VIM/${prefix}_large_decaps
write_design -directory VIM/${prefix}_large_decaps -name {top} -no_children
write_parms -command read_design -file etc/app-parms/${prefix}_large_decaps.parms
#prefill (nwell contacts)
echo “############ PREFILL ############”
current_cell -root
add_filler_cells -prefill
echo [cputime]
current_cell -root
check_placement -overlap
# save as_prefill
exec mkdir -p VIM/${prefix}_prefill
write_design -directory VIM/${prefix}_prefill -name {top} -no_children
write_parms -command read_design -file etc/app-parms/${prefix}_prefill.parms
# place wrappers
echo “############ Placing RA wrappers ##########”
source tcl/place_ra_wrappers.tcl
echo [cputime]
current_cell -root
check_placement -overlap
#Save as_wrappers
exec mkdir -p VIM/${prefix}_wrappers
write_design -directory VIM/${prefix}_wrappers -name {top} -no_children
write_parms -command read_design -file etc/app-parms/${prefix}_wrappers.parms
# ioaffinity placement
echo “############ Placing ioaffinity #############”
source tcl/io_affinity.fixwarn.tcl
io_affinity ioaffinity/io_affinity_pd.$edif_tag
echo [cputime]
current_cell -root
check_placement -overlap
# save as_affinitized
exec mkdir -p VIM/${prefix}_affinitized
write_design VIM/${prefix}_affinitized -name {top} -no_children
write_parms -command read_design -file etc/app-parms/${prefix}_affinitized.parms
# decaps around IO and SCBs
# NOTE: Place only 1 ring around!!
echo “############ Placing DECAPS ###############”
source tcl/place_decaps_if_space_2X_new.tcl
echo “############# Setting last_decap_from2X to $last_decap_from2X before calling
place_old_decaps_new.tcl ”
source tcl/place_old_decaps_new.tcl
# save as _decaps
exec mkdir -p VIM/${prefix}_decaps
write_design -force_specified_only -directory VIM/${prefix}_decaps -name {top}
write_parms -command read_design -file etc/app-parms/${prefix}_decaps.parms
echo [cputime]
current_cell -root
check_placement -overlap
# cplace with absolute movebounds!
echo “########### Starting cplace...... ############”
source tcl/cplace.tcl
echo [cputime]
check_placement -overlap -check_unplaced
### global route
#echo “########### Starting congestion analysis.... ############”
#source tcl/global_route.tcl
# save as _PLACED --- FORCE SAVE!
exec mkdir -p VIM/${prefix}_PLACED
write_design -force_specified_only -directory VIM/${prefix}_PLACED -name {top}
write_parms -command read_design -file etc/app-parms/${prefix}_placed.parms
# snap moves
source tcl/snap_move.tcl
echo [cputime]
check_placement -overlap
# save as_snap_moved
exec mkdir -p VIM/${prefix}_snap_moved
write_design -directory VIM/${prefix}_snap_moved -name {top} -no_children
write_parms -command read_design -file etc/app-parms/${prefix}_snap_moved.parms
# ScanOpt
optimize_scan_path -hierarchy_levels 99 -output_directory {HDP/reports} -chain_types {all}
# save as _scanOpted
exec mkdir -p VIM/${prefix}_scanOpted
write_design -directory VIM/${prefix}_scanOpted -name {top} -no_children
write_parms -command read_design -file etc/app-parms/${prefix}_scanOpted.parms
current_cell -root
check_placement -overlap
# ClockOpt
source tcl/clock_opt.tcl
# save as _clockOpted
exec mkdir -p VIM/${prefix}_clockOpted
write_design -directory VIM/${prefix}_clockOpted -name {top} -no_children
write_parms -command read_design -file etc/app-parms/${prefix}_clockOpted.parms
current_cell -root
check_placement -check_unplaced
# Legalize
source tcl/legalize.tcl
echo [cputime]
current_cell -root
check_placement -overlap -check_unplaced
echo “### FIXING all global clock cells in place!”
current_cell -root
select_cell -name “glob_clk_box_0_*”
set_location_fixed -value 1
current_cell -root
# Save as _legalized
exec mkdir -p VIM/${prefix}_LEGALIZED
write_design -force_specified_only -directory VIM/${prefix}_LEGALIZED -name {top}
write_parms -command read_design -file /etc/app-parms/${prefix}_LEGALIZED.parms
set_ignore_pin -scan FALSE -clock FALSE
PART 2: RUN TDCopt at this point
#### NEED TO GENERATE NEW clock optimization FILES FROM TDCOPTED VIM.
PART 3: Steps after TDCopt
# set prefix for current run
set prefix “VIM0426_pass1”
set edif_tag “EDIF0426”
echo [exec date]
echo $auto_path
# this list path that CB searches for tcl scripts
echo [get_parm_path]
# load _TDCOPT vim
# call legalize_after_tdcopt.tcl
# look at placement errors in member group window. Choose groups of fixed gates if necessary ,
# give list a name: set unfixed_splitters [list_selection] and unfix.
# Call legalize_after_tdcopt again.
# Fix the list of gates! set_location_fixed unfixed_splitters -value 1
# repeat as necessary
# Save VIM and parms so that you can load them for this tcl script.
# Therefore, save parms as: ${prefix}_tdcopt_LEGALIZED.parms as used below.
# read_tdcopt_LEGALIZED parms
read parms -command read design -file etc/app-parms/${prefix}_tdcopt_LEGALIZED.parms
report_parm -command read_design
read_design -name {top}
current_cell -root
check_placement -overlap -check_unplaced
# clockOpt
source tcl/clock_opt_glob_clk.tcl
echo [cputime]
# save as reOpted
exec mkdir -p VIM/${prefix}_reOpted
write_design -directory VIM/${prefix}_reOpted -name {top} -no_children
write_parms -command read_design -file etc/app-parms/${prefix}_reOpted.parms
# Legalize
source tcl/legalize_after_reOpt.tcl
# Save as _legalized
exec mkdir -p VIM/${prefix}_reOpted_LEGALIZED
write_design -force_specified_only -directory VIM/${prefix}_reOpted_LEGALIZED -name
{top}
write_parms -command read_design -file etc/app-
parms/${prefix}_reOpted_LEGALIZED.parms
current_cell -root
set_ignore_pin -scan FALSE -clock FALSE
set_ignore_pin -clock FALSE
source tcl/global_route.tcl
### rap/rc generation
source tcl/generate_cap_rc.tcl
echo [cputime]

After completion of step 14, the placed netlist may be provided to a layout vendor which will perform a real route of all the nets in the design in accordance with standard practice. Once all the nets are connected in the specified metal layers, the vendor may extract the actual parasitics (capacitance and resistance values), step 18 of the FIGURE, and provide the generated layout to the ASIC designer for timing analysis. The designer may then run static timing analysis on the real routes with actual parasitics, step 20 of the FIGURE, in accordance with standard practice. Specifically, the designer may feed the actual capacitance and resistance values back into the EINSTIMER™ software tool to determine whether timing requirements are met, according to one embodiment. If some paths fail to meet the timing requirements (block 22 of the FIGURE), the designer may have to go back to placement step 6 of the FIGURE, or to design synthesis step 2 depending on the severity of the problem. If no timing problems are encountered, or after all timing problems have been fixed (block 22 FIGURE), the tool flow process is complete.

A person skilled in the art would readily recognize that engineering change order (ECO)-type changes may be made if the timing results of step 20 contain errors which are relatively small. For example, the ASIC designer may add a few gates like buffers, or change the size of gates in the CHIPBENCH™ tool to fix some timing violations, like capacitance or slew or hold violations. To close timing later on, the designer may insert and place some buffers in the netlist or move some buffers around, or upsize some buffers and legalize the placement of the buffers, if needed, without additional effort.

The above-described novel tool flow process solves the instability problems associated with working with estimations of area and parasitics while working to get closure on timing, routing congestion and die area. The novel tool flow process increases the repeatability and predictability of results while smoothing out and stabilizing the analysis being done by the chip designer.

A person skilled in the art should appreciate that various other IC design methodology tools and/or configurations may be utilized in the above-described embodiments, provided that such other IC design methodology tools and/or configurations do not depart from the intended purpose and scope of the present invention.

While the present invention has been described in detail with regards to the preferred embodiments, it should also be appreciated that various modifications and variations may be made without departing from the scope or spirit of the invention. For example, the design synthesis and placement steps may be combined in a physically aware synthesis flow such as the one utilized by PHYSICAL COMPILER™ by Synopsys, Inc.

It is important to note that practicing the invention is not limited to the applications described hereinabove. Many other applications and/or alterations may be utilized provided that such other applications and/or alterations do not depart from the intended purpose of the present invention.

It should further be appreciated by a person skilled in the art that features illustrated or described as part of one embodiment can be used in another embodiment to provide yet another embodiment such that the features are not limited to the specific embodiments described above. Thus, it is intended that the present invention cover all such modifications, embodiments and variations as long as such modifications, embodiments and variations come within the scope of the appended claims and their equivalents.

What is claimed is:

1. A circuit design flow process comprising:
using a mapped gate-level netlist to pre-place critical electrical infrastructure on an integrated circuit (IC) die to ensure repeatability; and
placing the remaining electrical infrastructure on the IC die.

2. The circuit design flow process of claim 1, further comprising:
performing circuit optimization of the placed netlist based on timing estimates.

3. The circuit design flow process of claim 2, further comprising:
generating estimated routes and parasitics for the placed netlist; and
merging said estimated parasitics with other available parasitics from a plurality of sources.

4. The circuit design flow process of claim 3, further comprising:
running timing analysis on the placed netlist with said estimated routes and parasitics.

5. The circuit design flow process of claim 4, further comprising:
generating real routes for the nets from the placed netlist; and
extracting actual parasitics for the routed nets to generate an IC layout.

6. The circuit design flow process of claim 5, further comprising:
running timing analysis on the IC layout.

7. The circuit design flow process of claim 1, wherein the critical electrical infrastructure comprises at least one IO (input/output) circuit, at least one electro-static discharge (ESD) protection circuit, and at least one large register array/file.

8. The circuit design flow process of claim 7, wherein the critical electrical infrastructure further comprises at least one clock tree buffer, at least one bitstack (standard cell gate) structure, and at least one critical data path.

9. The circuit design flow process of claim 8, wherein the critical electrical infrastructure further comprises at least one de-coupling capacitor, and at least one boundary scan circuit.

10. The circuit design flow process of claim 1, wherein the pre-placement step includes inserting N-well taps at regular intervals around the IC die.

11. A circuit design flow process comprising:
generating a mapped gate-level netlist; and
using the gate-level netlist to pre-place critical electrical infrastructure on an integrated circuit (IC) die to ensure repeatability.

12. The circuit design flow process of claim 11, further comprising:
using the gate-level netlist to place the remaining electrical infrastructure on the IC die.

13. The circuit design flow process of claim 12, further comprising:
performing circuit optimization of the placed netlist based on timing estimates.

14. The circuit design flow process of claim 13, further comprising:
generating estimated routes and parasitics for the placed netlist; and
merging said estimated parasitics with other available parasitics from a plurality of sources.

15. The circuit design flow process of claim 14, further comprising:
running timing analysis on the placed netlist with said estimated routes and parasitics.

16. The circuit design flow process of claim 15, further comprising:
generating real routes for the nets from the placed netlist; and
extracting actual parasitics for the routed nets to generate an IC layout.

17. The circuit design flow process of claim 16, further comprising:
running timing analysis on the IC layout.

18. A circuit design flow process comprising:
generating a mapped gate-level netlist;
running the gate-level netlist through a design-for-test (DFT) and clock tree build stage; and
using the resultant netlist to pre-place critical electrical infrastructure on an integrated circuit (IC) die to ensure repeatability.

19. The circuit design flow process of claim 18, further comprising:
using the resultant gate-level netlist to place the remaining electrical infrastructure on the IC die.

20. A tool flow process for physical design of an integrated circuit (IC), comprising:
(a) using a design synthesis tool to generate a mapped gate-level netlist;
(b) using a master script to call a first tool to perform a design-for-test (DFT) and clock tree build of said gate-level netlist, the resultant netlist containing critical electrical infrastructure for utilization in the IC physical design;
(c) using said master script to call a second tool to perform pre-placement of said critical electrical infrastructure on an IC die to ensure repeatability;
(d) using said master script to call said second tool to perform placement of the remaining electrical infrastructure on the IC die, said placements constituting a placed netlist; and
(e) using said master script to call said second tool to perform circuit optimization of the placed netlist based on timing estimates.

21. The tool flow process of claim 20, further comprising:
(f) using said master script to call said second tool to perform scan connection and clock tree optimization of the placed netlist; and
(g) using said master script to call said second tool to perform clock tree re-optimization of the placed netlist.

22. The tool flow process of claim 21, further comprising:
(h) using said master script to call said second tool to generate estimated routes and parasitics for the placed netlist; and
(i) using said master script to call said first and second tools to merge said estimated parasitics with available parasitics from a plurality of sources.

23. The tool flow process of claim 22, further comprising:
(j) using said master script to call a third tool to run timing analysis on the placed netlist with said estimated routes and parasitics.

24. The tool flow process of claim 23, further comprising:
(k) generating real routes for the nets from the placed netlist; and
(l) extracting actual parasitics for the routed nets to generate an IC layout.

25. The tool flow process of claim 24, further comprising the step of running timing analysis on the IC layout.
